(19) United States
(12) Patent Application Publication
(10) Pub. No.: US 2010/0272872 A1
(43) Pub. Date: Oct. 28, 2010

(54) Gas Mixture for Dosing Liquids with Sulphur Dioxide and Method for using the Same

(75) Inventor: Donald Allen, Wynn Vale South (AU)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Ex ploitation Des Procedes Georges Claude, Paris (FR)

(21) Appl. No.: 12/664,985

(22) PCT Filed: Jun. 12, 2008
(86) PCT No.: PCT/EP08/57426

§ 371 Date: Jun. 14, 2010

(30) Foreign Application Priority Data
Jun. 25, 2007 (AU) 2007903409

(51) Int. Cl. A23C 9/152; C09K 3/00; A23L 2/54; A23L 3/3409; C12G 1/04; C12C 5/02; C12H 1/14; B65B 3/00

(52) U.S. Cl. 426/312; 252/372; 206/6

(57) ABSTRACT

A gas mixture containing from about 5% by volume to about 40% by volume of sulphur dioxide with the balance, except for incidental constituents not adversely affecting the basic properties of the gas mixture, being a carrier gas. Also disclosed is a method for dosing a volume of liquid with sulphur dioxide, the method including introducing the gas mixture into a volume of liquid at a flow rate and for a period of time sufficient to add a dosage amount of sulphur dioxide to a volume of liquid.

This application claims priority from Australian provisional patent application No. 2007903409 filed on 25 Jun. 2007, the contents of which are to be taken as incorporated herein by this reference.

The present invention relates to gas mixtures containing sulphur dioxide. The gas mixtures find use in the food and related industries for dosing liquid foodstuffs, such as wine, with antibiotic or antioxidant amounts of sulphur dioxide.

Sulphur dioxide (SO₂) is a colourless gas that is used extensively in the food and beverage industries as a preservative due to its antimicrobial and antioxidant properties. For example, sulphur dioxide is used in the wine industry as an antioxidant in the winemaking process. Sulphur dioxide is used in a number of forms in the food industry, including sulphur dioxide gas, sulphur dioxide liquid (i.e. pressurised gas), potassium metabisulphite (PMS) powder or formed shapes such as prills, granules, pellets, pastilles or flakes.

Generally, the use of sulphur dioxide is problematic because it is a highly toxic gas. Indeed, the safe use of sulphur dioxide is regulated and STEL (short term exposure limits) are set at <0.2 parts per million (ppm) for a 1 hour exposure. The IDHL (immediate danger to health and life limit) is 100 ppm. However, exposure to concentrations of as little as 10 to 50 ppm sulphur dioxide for 5 to 15 minutes can cause irritation of the eyes, nose and throat, choking and coughing. Exposure of the eyes or skin to liquid sulfur dioxide can cause severe burns. Other health effects that can result from exposure to sulfur dioxie include headache, general discomfort, and anxiety. Repeated or prolonged exposure to moderate concentrations of sulphur dioxide can cause inflammation of the respiratory tract, wheezing and lung damage. From an environmental viewpoint, sulphur dioxide can react with moisture to form acid rain.

Sulphur dioxide is added during the winemaking cycle at about six stages. The dosing process typically involves filling a measure (“sulphitometer”) with sulphur dioxide liquid from a cylinder. Depending on the type of cylinder, the process may involve inverting the cylinder. Typically, the loaded sulphitometer is then carried up a series of ladders and catwalks to the top of the wine tank, where it is emptied into the tank. The wine in the tank is then agitated to mix the sulphur, and ensure the dose is provided evenly through the wine. When adding sulphur dioxide to wine, it is important to ensure that it is evenly distributed in the must or wine. To achieve this it is best to inject the sulphur dioxide steadily, typically during a transfer, pumping or racking (wine tank agitation) procedure to ensure a homogenous addition.

Due to the toxic nature of sulphur dioxide, dosing a tank of wine with sulphur dioxide is one of the more unpleasant and hazardous tasks a wine cellar hand will be called on to perform, and it is recommended that it only be done by a suitably trained and equipped person. Accidents involving sulphur dioxide in the wine industry have been caused by brief exposure to high levels of liquid or gaseous sulphur dioxide, usually resulting from malfunction of equipment such as sulphitometers. These may be due to leaking or blocked valves, or incorrect operation of the equipment.

There is a need for a gas mixture and process for dosing wine and other liquid foodstuffs with sulphur dioxide that alleviates one or more of the problems associated with the prior art processes.

The discussion of the background to the invention herein is included to explain the context of the invention. This is not to be taken as an admission that any of the material referred to was published, known or part of the common general knowledge as at the priority date of any of the claims.

The present inventors have found that a mixture of sulphur dioxide gas with an inert carrier gas enables accurate and safe dosing of sulphur dioxide in a gaseous form into a wine tank. The use of the gas mixture ameliorates at least some of the safety and handling problems associated with current dosing procedures and provides a more homogenous addition.

The present invention provides a gas mixture including from about 5% by volume to about 40% by volume of sulphur dioxide with the balance, except for incidental constituents not adversely affecting the basic properties of the gas mixture, being a carrier gas.

The present invention also provides a method for dosing a volume of liquid with sulphur dioxide, the method including:
determining a sulphur dioxide dosage amount for said volume;
providing a gas mixture including from about 5% by volume to about 40% by volume of sulphur dioxide with the balance, except for incidental constituents not adversely affecting the basic properties of the gas mixture, being a carrier gas; and
introducing said gas mixture into said volume of liquid at a flow rate and for a period of time sufficient to add said dosage amount of sulphur dioxide to said volume of liquid.

The present invention also provides a container containing a gas mixture, the gas mixture including from about 5% by volume to about 40% by volume of sulphur dioxide with the balance, except for incidental constituents not adversely affecting the basic properties of the gas mixture, being a carrier gas.

The carrier gas may be an inert gas, such as nitrogen or carbon dioxide, or any “noble” gas (namely, argon, xenon, krypton, helium, neon and radium). The carrier gas may also be a mixture of any two or more of these gases.

The liquid to be dosed with sulphur dioxide may be a liquid foodstuff, including (but not limited to) wine, fruit juices, beer, milk, beverages, and oil. In an embodiment of the invention the liquid foodstuff is wine.

A dosage amount of about 2 milligrams to about 200 milligrams sulphur dioxide per litre of liquid is typical for liquid foodstuffs. For example, a typical sulphur dioxide level in wine will depend on the acidity (pH), but will typically be in the range of about 10 milligrams per litre to about 40 milligrams per litre. A dosage amount of about 25 milligrams of sulphur dioxide per litre of liquid is typical for wine.

Various embodiments of the present invention will now be described in more detail. However, it must be appreciated that the following description is not to limit the generality of the above description.

Unless otherwise stated, all gas percentages in this specification and in the claims are by volume.

The gas mixtures of the present invention comprise from about 5% to about 40% sulphur dioxide and the balance, except for incidental constituents not adversely affecting the basic properties of the gas mixture, being an inert gas. The amount of sulphur dioxide in the gas mixture may be selected from the group consisting of 5 to 40%, 10 to 40%, 15 to 40%, 20 to 40%, 25 to 40%, 30 to 40%, 35 to 40%, 5 to 10%, 5 to 15%, 5 to 20%, 5 to 25%, 5 to 30%, 5 to 35%, 10 to 35%, 15 to 30%, and 20 to 25%.

It is contemplated that the gas mixture may include incidental constituents that do not adversely affect the basic properties of the gas mixture. Examples of such constituents include water vapour, oxygen, or other gases. It will be understood that these constituents may be present in amounts that are relatively minor and, therefore, their presence does not adversely affect the basic properties of the gas mixture.

Any inert gas may be used as the carrier gas. The carrier gas may be selected based on the nature of the liquid foodstuff. The carrier gas may be selected from the group consisting of nitrogen, carbon dioxide, and a “noble” gas such as argon, xenon, krypton, helium, neon, and radium. The carrier gas may also be a mixture of any two or more of these gases. Typical carrier gases that may be used include nitrogen, argon, helium, and carbon dioxide. In an embodiment of the invention useful for dosing wines with sulphur dioxide, the carrier gas is nitrogen.

The use of nitrogen as the carrier gas provides additional benefits other than assisting the dosing of the sulphur dioxide. One of the other critical elements in achieving wine quality is the dissolved oxygen level. The use of nitrogen as the carrier gas therefore will additionally assist in reducing dissolved oxygen in wine by combining with the dissolved oxygen, and sparging it from the wine. This enables the dissolved oxygen level to be controlled or reduced at the same time as the nitrogen is being used as a carrier gas for the sulphur dioxide dosing.

The gas mixture is stored in a container. Typically, the container will be a cylinder containing between about 5% and about 40% sulphur dioxide in a liquid form, with the balance being the carrier gas. The carrier gas is a pressurizing medium that assists the flow of sulphur dioxide into the volume of liquid to be dosed. The cylinder is an “F” sized cylinder that typically contains around 250 grams of sulphur dioxide and is pressurized to 15 to 25 bar. Thus, each cylinder will typically contain sufficient sulphur dioxide to dose a wine tank up to 10,000 litres with 40 milligrams per litre sulphur dioxide.

The filling process for the gas mixture will typically be carried out in a cylinder facility dedicated to the production or filling of laboratory and analytical grade gases. The processes involved in the filling of the sulphur dioxide gas mixture involve firstly connecting the cylinder to the laboratory gas filling manifold, and then drawing a vacuum on the cylinder. The correct dosage rate of sulphur dioxide is calculated by an Algomix computer program, and the sulphur dioxide added to the set pressure required. The carrier gas, typically nitrogen, is then added by weight. Batch process control is carried out to ensure the mixture precision.

The cylinder may be fitted with a dedicated toxic gas cylinder valve to ensure only sulphur dioxide rated regulators or other dosing mechanisms are employed. The cylinder will typically be clearly marked with a colour band compliant with the appropriate National standard, such as the appropriate Australian standard. It will additionally be fitted with a top carrying handle designed to protect the valve and readily identify the contents.

The gas mixture may be particularly useful for dosing wine with sulphur dioxide, and the following discussion illustrates such a use. However, it will be appreciated that the gas mixture could also be used to dose other liquids with sulphur dioxide. Typically, the other liquids will be liquid foodstuffs, such as beer, fruit juices, and similar beverages.

The use of sulphur dioxide is an almost universally accepted winemaking practice. It is added at most stages of the white winemaking process, from crushing through to bottling. It is used less liberally during red winemaking, but with an almost mandatory addition being made following the completion of the malolactic fermentation of these wines.

To dose a wine tank with sulphur dioxide, one must first determine a sulphur dioxide dosage amount for the volume of wine in the tank. The sulphur dioxide dosage required depends on the pH of the wine, but will typically be in the range of about 10 milligrams to about 40 milligrams of sulphur dioxide per litre of wine. A dosage amount of about 25 milligrams of sulphur dioxide per litre of wine is fairly typical.

The antioxidant and antimicrobial effects of sulphur dioxide in wine are thought to arise from the presence of ‘free’ sulphur dioxide. Typically, about 60% of the sulphur dioxide added to wine is present as free sulphur dioxide, and the remainder occurs as bound sulphur dioxide. Of the free sulphur dioxide, a certain portion will be in the form of molecular sulphur dioxide, which is the species responsible for the antioxidant and antimicrobial effects. The proportion of molecular sulphur dioxide decreases as the pH of the wine increases.

The person skilled in the art will be able to determine the amount of molecular sulphur dioxide required for a given volume of wine and, hence, the dosage of sulphur dioxide gas mixture required to provide the required level of molecular sulphur dioxide. For example, the following table shows the level of free sulphur dioxide needed to give 0.8 ppm molecular sulphur dioxide.

| pH | Free sulphur dioxide |
|---|---|
| 3.0 | 13 |
| 3.1 | 16 |
| 3.2 | 21 |
| 3.3 | 26 |
| 3.4 | 32 |
| 3.5 | 40 |
| 3.6 | 50 |
| 3.7 | 60 |

The level of molecular sulfur dioxide can also be calculated by the formula below.

Molecular SO₂(ppm)=free SO₂/(1+10^{(pH-1.83)})

A typical sulphur dioxide level in wine will depend on the acidity (pH), but may well be in the range of 10 to 40 milligrams per litre.

The gas mixture is introduced into the volume of wine at a flow rate and for a period of time sufficient to add said dosage amount of sulphur dioxide to said volume of wine. The flow rate for the cylinder contents will typically be between about 5 and about 100 litres per minute. Once the flow rate has been set, the correct dosing period can be calculated.

The cylinder is preferably fitted with an appropriate cylinder regulator. The regulator pressure may be set at between 1 and 3 bar.

A hose of sufficient length, and of an approved material, is then connected at one end to the regulator and at the other end to either the top of the wine tank or a bottom wine tank racking or similar valve.

In the case of dosing through the top of the tank, a sinter may be fitted to the supply end of the hose. The sinter may be a stainless steel sinter of approximately 25 mm diameter and 100 mm to 150 mm length. The sinter is then lowered into the wine tank to a suitable depth, such as to about 25% of the height minimum. This allows the sulphur dioxide gas and carrier gas to be bubbled through the volume of wine in the tank.

In the case of dosing through the bottom of the tank, the supply end of the hose is fitted to the wine tank racking or similar valve on the bottom of the tank using standard couplings.

Once the cylinder is connected to the tank via the hose, the regulator is opened and the gas mixture is allowed to flow through the wine for the predetermined dosage time. The cylinder valve is then closed, the hose is disconnected and drained of residual sulphur dioxide. The hose may be cleaned with a suitable process for future use.

The gas mixture and methods described herein may provide a number of advantages, including:
1. Providing a safe and accurate means of dosing sulphur dioxide into wine tanks.
2. Eliminating the necessity to decant liquid sulphur dioxide into a sulphitometer.
3. Eliminating the possibility of liquid sulphur dioxide spills.
4. Eliminating the necessity to carry sulphitometers containing liquid sulphur dioxide up winery ladders and catwalks.
5. Reducing the risks of eye injury.
6. Reducing the risk of upper respiratory tract irritation.
7. Reducing the risk of heart disease.
8. Reducing the risk of acid rain.

Due to the percentage of sulphur dioxide, the gas mixture is not categorised as being toxic under the ISO 10298 standard, for a mixture based on the LC50 (lethal concentration). The LC50 of sulphur dioxide is 2,520 ppm. Therefore the ISO 10298 standard shows that any mixture of sulphur dioxide under 50.4% is categorised as being non toxic.

The embodiments have been described by way of example only and modifications within the spirit and scope of the invention are envisaged. Thus, it must be appreciated that there may be other modifications to the configurations described herein which are also within the scope of the present invention.

1-12. (canceled)

13. A gas mixture including from about 5% by volume to about 40% by volume of sulphur dioxide and a carrier gas.

14. The gas mixture of claim 13, wherein the carrier gas is an inert gas.

15. The gas mixture of claim 13, wherein the carrier gas is selected from the group consisting of nitrogen, argon, xenon, krypton, helium, neon radium, and carbon dioxide.

16. A method for dosing a volume of liquid with sulphur dioxide, the method including:
determining a sulphur dioxide dosage amount for said volume;
providing a gas mixture including from about 5% by volume to about 40% by volume of sulphur dioxide and a carrier gas; and
introducing said gas mixture into said volume of liquid at a flow rate and for a period of time sufficient to add said dosage amount of sulphur dioxide to said volume of liquid.

17. The method of claim 16, wherein the liquid to be dosed with sulphur dioxide is a liquid foodstuff.

18. The method of claim 17, wherein the liquid foodstuff is selected from the group consisting of wine, beer, fruit juice, milk, and oil.

19. The method of claim 18, wherein the liquid foodstuff is wine.

20. The method of claim 16, wherein the dosage amount is about 2 milligrams to about 200 milligrams sulphur dioxide per litre of liquid.

21. The method of claim 19, wherein the dosage amount is about 10 milligrams to about 40 milligrams per litre.

22. A container containing a gas mixture, the gas mixture including from about 5% by volume to about 40% by volume of sulphur dioxide and a carrier gas.

23. The container of claim 22, wherein the carrier gas is an inert gas.

24. The container of claim 22, wherein the carrier gas is selected from the group consisting of nitrogen, argon, xenon, krypton, helium, neon radium, and carbon dioxide.
